(19) United States
(12) Patent Application Publication
(10) Pub. No.: US 2003/0211206 A1
(43) Pub. Date: Nov. 13, 2003

(54) Food product and packaging therefor

(76) Inventors: Stacy Edelen Sharp, Florissant, MO (US); Kristine G. Hittner, Florissant, MO (US); Susan L. Russo, Florissant, MO (US); Tracy A. Wotring, St. Louis, MO (US)

Correspondence Address: John S. Beulick, Armstrong Teasdale LLP, Suite 2600, One Metropolitan Sq., St. Louis, MO, 63102, US

(21) Appl. No.: 10/141,613

(22) Filed: May 8, 2002

(51) Int. Cl. A23B 4/00

(52) U.S. Cl. 426/115

(57) ABSTRACT

A packaged food product includes a plurality of cups which contain a mixture of gelatin powder, flavoring, water, and a distilled alcohol product, a plurality of lids configured to snap fit on the cups, and a container configured for packaging the cups with the lids snapped in place.

### BACKGROUND OF THE INVENTION

This invention relates generally to food products, and more specifically to, ready to consume food products.

People enjoy gathering with families, friends, peers, and co-workers in casual settings. Families often gather to celebrate events such as birthdays, anniversaries, and holidays. In addition, co-workers often gather in places other than the workplace setting to enjoy a more relaxed environment. Often, an individual will host the family or co-worker gathering in their home where everyone can relax and visit with one another. Such gatherings may include food and beverage selections. Typical food selections are generally referred to as finger foods. Many guests will feel compelled to contribute by bringing various finger foods and beverages to the gathering in order to take some of the burden away from the host or hostess. Many such guests and hosts wish to provide food and beverage selections which are fast and easy to make, but at the same time also innovative, fun and delicious.

### BRIEF SUMMARY OF THE INVENTION

In one aspect a packaged food product is provided. The packaged product comprises a plurality of cups, the cups containing a mixture of a gelatin powder, a flavoring, water, and a distilled alcohol product. The product further comprises a plurality of lids configured to fit onto the cups, and a container configured for packaging the cups with the lids in place.

In another aspect, a kit is provided. The kit comprises a container of distilled alcohol, a package of gelatin, and a plurality of serving containers.

In another aspect, a packaged food product is provided. The packaged product comprises a plurality of cups containing a mixture of gelatin powder, flavoring, water, and a distilled alcohol product. The cups are configured to hold a volume of between one-half ounce and three ounces. The packaged food product further comprises a plurality of lids configured to fit onto the cups and a container configured for packaging said cups with said lids in place, said container being configured to hold between two and 100 of the cups and the lids with the mixture.

### BRIEF DESCRIPTION OF THE DRAWINGS

FIG. 1 is a perspective view of a container and lid for a single serving of a gelatin and alcohol based food product.

FIG. 2 is a cut away view of the container and lid of FIG. 1.

FIG. 3 is a view of a packaging scheme for the food product of FIG. 1.

FIG. 4 is a diagram illustrating a kit for preparing the food product of FIG. 1.

### DETAILED DESCRIPTION OF THE INVENTION

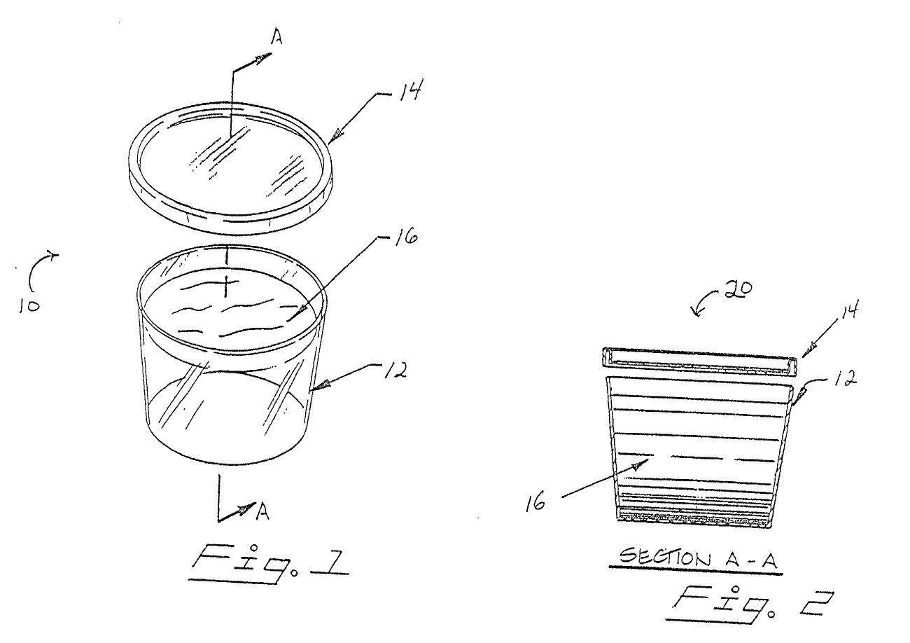

FIG. 1 is a perspective view of a single serving 10 of a packaged food product which includes a cup 12 and lid 14 for a single serving of a gelatin and an alcohol based food product 16. In alternative embodiments, cups 12 are sometimes referred to herein as serving containers, for reasons which are evident below. Also, as used herein, cups 12 is to be construed include, but not be limited to, cups, molds, containers, and cups which include lids. Food product 16 is, for example, a mixture of gelatin powder, flavoring, water, and a distilled alcohol product.

In one embodiment, the food product is packaged to include a plurality of cups 12 and lids 14, which in one embodiment are constructed of molded plastic. In one embodiment, lids 14 are configured to snap-fit onto cups 12. In an alternative embodiment, not shown, lids 14 are hermetically sealed to cups 12, and are peeled back for access to food product 16.

As shown in FIG. 1, cup 12 and lid 14 are circular in shape. Other embodiments are contemplated however. Such embodiments include, but are not limited to incorporation of a festive or holiday shape within the cups and lids, as well as other shapes. Examples of festive and holiday shapes include, but are not limited to, a star shape, a Christmas tree shape, a football shape, an animal shape, a pumpkin shape, a bell shape, and a clover shape. Shaping of cups 12 works to provide a molded shape for food product 16 upon serving. Food product 16 may also be served outside of cup 12, for example on a tray, while retaining the festive shape. To serve outside of cup 12, lid 14 is removed, and food product 16 is carefully removed from cup 12 and onto the the serving tray.

In alternative embodiments, the distilled alcohol product within product 16 is one or more of, but is not limited to, rum, vodka, gin, whiskey, bourbon, champagne, wine, sparkling wine, scotch, brandy, liqueur, tequila, and grain alcohol. In an alternative embodiment, the flavoring within product 16 includes, but is not limited to, at least one of cherry flavoring, grape flavoring, lemon flavoring, lime flavoring, watermelon flavoring, strawberry flavoring, orange flavoring, raspberry flavoring, blueberry flavoring, and apple flavoring.

It is known within the art that flavoring does not necessarily impart coloration. It is further well known that certain coloration enhances the appeal of food products. In one embodiment, a coloring additive is included with the flavoring which is aesthetically compatible with the flavoring. For example, a color additive of yellow may be added to lemon flavoring, but typically not to a cherry flavoring. However, it is to be understood that the examples are illustrative only, since it is known that multiple base color additives are used to arrive at a final coloration (i.e. a particular red coloration may include a portion of a yellow color additive).

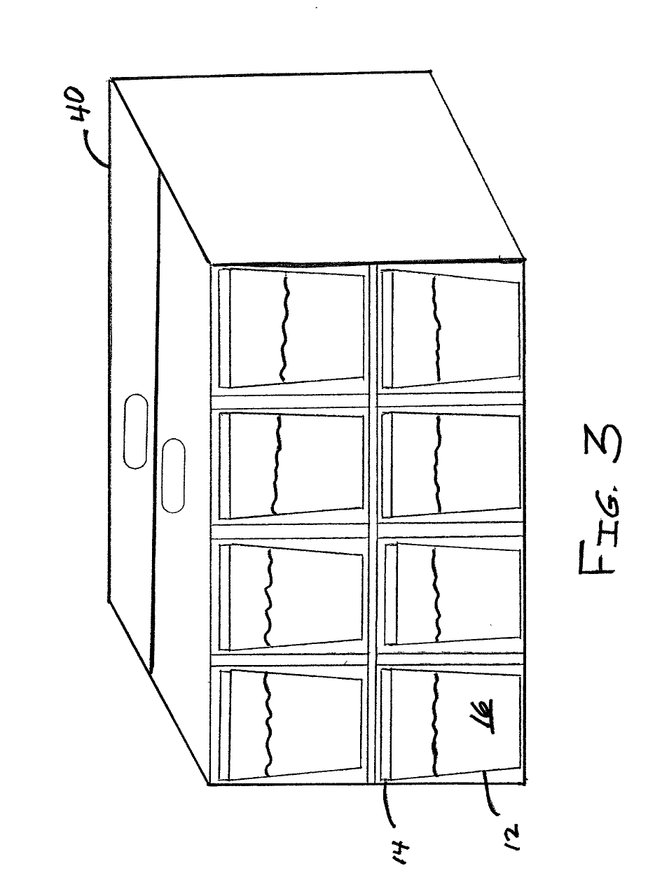

FIG. 2 is a cutaway view 20 of cup 12, lid 14 and food product 16. FIG. 2 illustrates that cup 12 is not necessarily filled to a brim 22 with food product 16. In practice, cups 12 are filled to point where food product 16 is easily accessible and may be easily removed from cup 12 for ingestion. In one embodiment, cups 12 are configured to hold a volume of between one-half ounce and three ounces, inclusive.

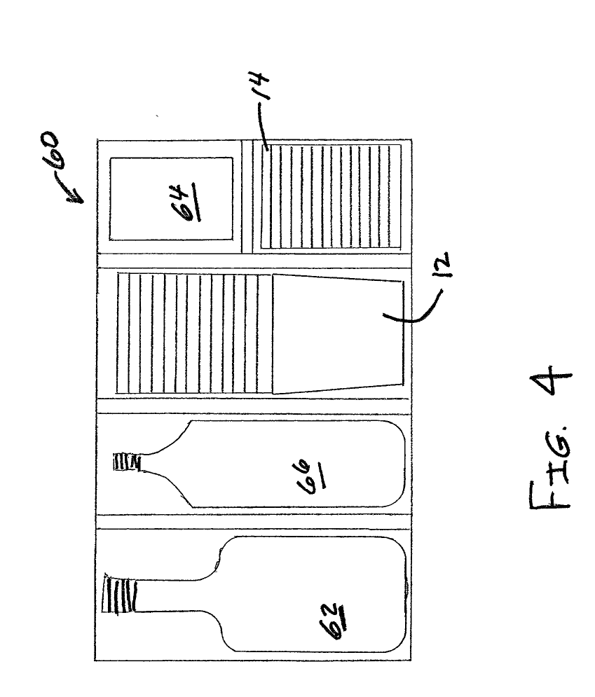

FIG. 3 is a perspective view of a container 40 configured for packaging a plurality of cups 12 and lids 14. Cups 12 contain a quantity of food product 16. In particular embodiments, container 40 is configured to hold between two and 100 of cups 12 and lids 14. In one particular embodiment, container 40 is configured to hold 24 cups 12 and lids 14. While container 40 is shown as being transparent, so that a consumer may see samples of the packaged food product, it is contemplated that other types of packaging may be used, including but not limited to opaque plastic, paper, cardboard, and styrofoam. It is contemplated that materials used to construct container 40 be conducive to storage in refrigerated conditions, as embodiments of food product 16 may require refrigeration. Of course embodiments of food product 16 which do not require refrigeration are also contemplated.

FIG. 4 illustrates one embodiment of a kit 60 which is utilized to prepare portions of food product 16 (shown in FIGS. 1 and 3). Kit 60 includes a container of distilled alcohol 62, a package of gelatin 64, a plurality of cups 12, and a plurality of lids 14 configured to snap-fit to cups 12. In an alternative embodiment of kit 60, serving containers (cups 12), may optionally not be supplied with lids 14, and are considered to be molds. In both embodiments of kits 60 described, it is to be understood that the serving containers may be supplied in the previously described festive shapes, to provide a molded shape for the finished food product.

In the embodiment shown, an optional container 66 with water is provided. In a further embodiment, gelatin 64 includes one or more of a flavoring additive and an analogous coloring additive, as explained above.

As described above, container of distilled alcohol 62 includes at least one of rum, vodka, gin, whiskey, bourbon, champagne, wine, sparkling wine, scotch, brandy, liqueur, tequila, and grain alcohol. In one embodiment, an amount of alcohol in container 62, an amount of water in container 66 and an amount of gelatin in package of gelatin 64 are provided in proportions which will enable the final food product to gelatinize or solidify. A consumer simply mixes alcohol 62, gelatin 64, and water 66, under appropriate conditions, for example, water 66 boiling, and pours the mixture while still in a liquid form into cups 12. Lids 14, if supplied, are snapped onto cups 12, and refrigerated, which allows the food product to gelatinize. No measurements are made by the consumer which provides for a quick and easy product.

Such a product as kit 60 allows a consumer to rapidly prepare a tasty and popular food product without having to concern themselves about the quantity required of each ingredient to successfully prepare the described product. In addition, pre-made products, such as those in container 40 (shown in FIG. 3) allow consumers to buy, for example, at a grocer, a quantity of the tasty and popular food product, which can be served at gatherings and parties.

While the invention has been described in terms of various specific embodiments, those skilled in the art will recognize that the invention can be practiced with modification within the spirit and scope of the claims.

What is claimed is:

1. A packaged food product comprising:
a plurality of cups containing a mixture of gelatin powder, flavoring, water, and a distilled alcohol product;
a plurality of lids configured to fit onto said cups; and
a container configured for packaging said cups with said lids in place.

2. A packaged food product according to claim 1 wherein said container is configured to hold between two and 100 of said cups and lids.

3. A packaged food product according to claim 1 wherein said container is configured to hold 24 of said cups and lids.

4. A packaged food product according to claim 1 wherein said distilled alcohol product comprises at least one of rum, vodka, gin, whiskey, bourbon, champagne, wine, sparkling wine, scotch, brandy, liqueur, tequila, and grain alcohol.

5. A packaged food product according to claim 1 wherein said flavoring comprises at least one of cherry, grape, lemon, lime, watermelon, strawberry, orange, raspberry, blueberry, and apple.

6. A packaged food product according to claim 1 wherein said cup and said lid are constructed of molded plastic, and said lid is configured to snap fit onto said cup.

7. A packaged food product according to claim 1 wherein said cup and said lid are circular in shape.

8. A packaged food product according to claim 1 wherein said lid is configured to be hermetically sealed to said cup, said lid further configured to peel back from said cup.

9. A packaged food product according to claim 1 wherein said cup and said lid incorporate a festive or holiday shape.

10. A packaged food product according to claim 9 wherein said cup and said lid comprises at least one of a star shape, a Christmas tree shape, a football shape, an animal shape, a pumpkin shape, a bell shape, and a clover shape.

11. A packaged food product according to claim 1 further comprising a coloring additive, said additive being aesthetically compatible with said flavoring.

12. A packaged food product according to claim 1 wherein said cups are configured to hold a volume of between one-half ounce and three ounces, inclusive.

13. A kit comprising:
a container of distilled alcohol;
a package of gelatin; and
a plurality of serving containers.

14. A kit according to claim 13 wherein said package of gelatin further comprises flavoring.

15. A kit according to claim 14 wherein said flavoring comprises at least one of cherry grape, lemon, lime, watermelon, strawberry, orange, raspberry, blueberry, and apple.

16. A kit according to claim 14 further comprising a coloring additive mixed with said flavoring, said coloring additive being aesthetically compatible with a flavor of said flavoring.

17. A kit according to claim 13 wherein said container of distilled alcohol comprises at least one of rum, vodka, gin, whiskey, bourbon, champagne, wine, sparkling wine, scotch, brandy, liqueur, tequila, and grain alcohol.

18. A kit according to claim 13 further comprising a container of water.

19. A kit according to claim 18 wherein said container of water, said container of alcohol, and said package of gelatin are packaged in proportions which allow a combination of the water, alcohol, and gelatin to gelatinize.

20. A kit according to claim 19 wherein said serving containers are configured as molds and provide a molded shape to the gelatinized combination.

21. A kit according to claim 13 further comprising a plurality of lids configured to snap-fit to said serving containers.

22. A packaged food product comprising:
a plurality of cups containing a mixture of gelatin powder, flavoring, water, and a distilled alcohol product, said cups configured to hold a volume of between one-half ounce and three ounces;
a plurality of lids configured to fit onto said cups; and
a container configured for packaging said cups with said lids in place, said container being configured to hold between two and 100 of said cups and said lids, said cups each containing a portion of the mixture.
